(19) United States
(12) Patent Application Publication
(10) Pub. No.: US 2014/0202384 A1
(43) Pub. Date: Jul. 24, 2014

(54) GLUE SPREADING SYSTEM

(71) Applicant: HON HAI PRECISION INDUSTRY CO., LTD., NEW TAIPEI (TW)

(72) Inventor: CHIA-LING HSU, New Taipei (TW)

(73) Assignee: HON HAI PRECISION INDUSTRY CO., LTD., New Taipei (TW)

(21) Appl. No.: 14/014,383

(22) Filed: Aug. 30, 2013

(30) Foreign Application Priority Data
Jan. 24, 2013 (TW) 102102554

(51) Int. Cl. B05C 11/02

(52) U.S. Cl. CPC B05C 11/025
USPC 118/712

(57) ABSTRACT

A glue spreading system includes a spreading unit and a control unit. The spreading unit includes a primary pressing roller and a spreading roller. The spreading roller is adjacent to the primary pressing roller. A thin film transports between the primary pressing roller and the spreading roller. The spreading roller is configured for spreading a glue layer on the thin film. An actual thickness of the glue layer is decided by a pressure of the primary pressing roller applied on the spreading roller. The control unit is configured for detecting the actual thickness of the glue layer, and compares the actual thickness with a preset thickness. The control unit controls the pressure of the primary pressing roller applying on the spreading roller according to thickness differences between the actual thickness and the preset thickness.

### BACKGROUND

1. Technical Field

The present disclosure relates to glue spreading systems and, particularly, to a glue spreading system capable of uniformly spreading a glue layer on a thin film.

2. Description of Related Art

Some optical films include a thin film and a glue layer spreading on the thin film by roll-to-roll pressing. A thickness of the glue layer is mainly determined by a pressure of a pressing roller applied on a molding roller and other factors, such as environmental temperature or humidity. To obtain a desired thickness, the pressure should be adjusted depending on the other factors. However, at present, such adjustment is typically accomplished by manual operations, which is carried out under varying criteria and is low-efficient.

Therefore, it is desirable to provide a glue spreading system that can overcome the limitations described.

### BRIEF DESCRIPTION OF THE DRAWINGS

FIG. 1 is a schematic view of a glue spreading system in accordance with an exemplary embodiment.

FIG. 2 is a cross-sectional schematic view of a spreading roller and an optical film of the glue spreading system of FIG. 1.

### DETAILED DESCRIPTION

Embodiments of the disclosure will be described with reference to the drawings.

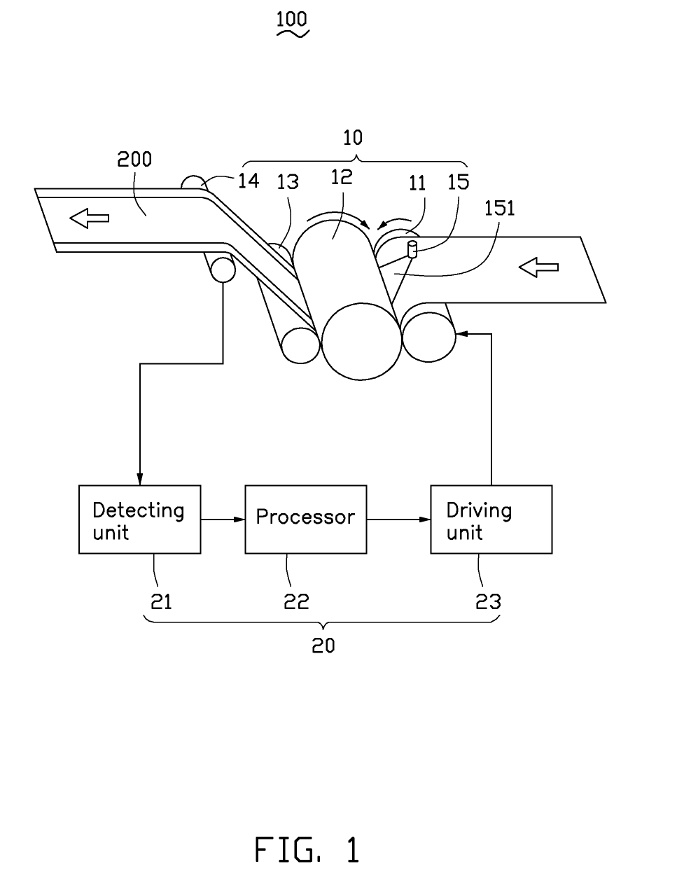

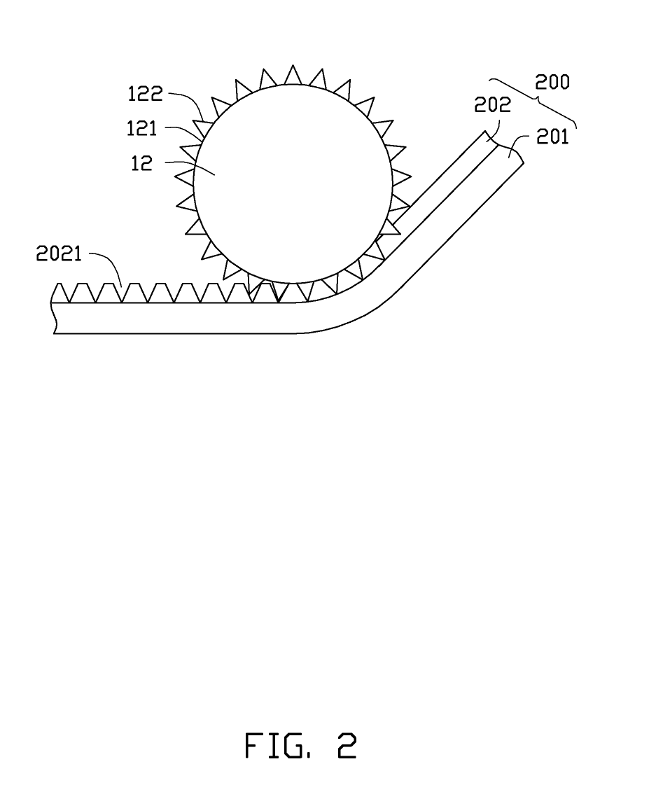

FIG. 1-2 show a glue spreading system 100, according to an exemplary embodiment, configured for molding an optical film 200. The optical film 200 includes a thin film 201 and a glue layer 202 spreading on the thin film 201. The glue spreading system 100 includes a spreading unit 10 and a control unit 20.

The spreading unit 10 includes a primary pressing roller 11, a spreading roller 12, a secondary pressing roller 13, a guiding roller 14, and a spurting device 15. The primary pressing roller 11, the spreading roller 12, the secondary pressing roller 13, and the guiding roller 14 are arranged along a transport direction of the thin film 201. The primary pressing roller 11, the secondary pressing roller 13, and the guiding roller 14 face one side of the optical film 200, and the spreading roller 12 and the spurting device 15 face another side of the optical film 200. The spurting device 15 is positioned above the primary pressing roller 11. The spreading roller 12 includes an outer surface 121, and defines a number of micro-structures 122 on the outer surface 121.

In the embodiment, a diameter of the spreading roller 12 is greater than a diameter of each of the primary pressing roller 11 and the secondary pressing roller 13. A height of the guiding roller 14 is higher than a height of the secondary pressing roller 13. The primary pressing roller 11, the secondary pressing roller 13 and the guiding roller 14 rotate in a counter-clockwise direction, and the spreading roller 12 rotates in a clockwise direction.

The spurting device 15 is configured for spurting glue 151 on the thin film 201. The glue 151 spurted on the thin film 201 is uniformly spread to the glue layer 202 by the spreading roller 12. A number of optical structures 2021 are defined on the glue layer 202 by the micro-structures 122 of the spreading roller 12. A shape of each optical structure 2021 corresponds to a shape of each micro-structure 122. A pressure of the primary pressing roller 11 applied on the spreading roller 12 is adjusted by adjusting a position of the primary pressing roller 11 corresponding to the spreading roller 12, therefore an actual thickness of the glue layer 202 is adjusted. The secondary pressing roller 13 is configured for adjusting the actual thickness of the glue layer 202 cooperating with the primary pressing roller 11. The guiding roller 14 is configured for adjusting the transport direction of the thin film 201.

The control unit 20 includes a detecting unit 21, a processor 22, and a driving unit 23. The processor 22 is electrically connected between the detecting unit 21 and the driving unit 23.

The detecting unit 21 is positioned above the guiding roller 14 and is configured for detecting the actual thickness of the glue layer 202. A part of laser light rays emitted from the detecting unit 21 is reflected by the glue layer 202, and forms a first reflecting laser. Another part of laser light rays emitted from the detecting unit 21 penetrates the glue layer 202 and is reflected by the thin film 201, and forms a second laser. The actual thickness of the glue layer 202 is calculated according to an optical path difference of the first reflecting laser and the second reflecting laser.

In this embodiment, the detecting unit 21 includes two spectroscopic reflectometries, and the spectroscopic reflectometries are adjacent to two opposite long edges of the glue layer 202.

The processor 22 stores a preset thickness of the glue layer 202, and outputs driving signals to the driving unit 23. The driving signals are calculated according to the thickness difference between the preset thickness and the actual thickness. Each driving signal corresponds to a pressure of the primary pressing roller 11 needed to add on the spreading roller 12.

When the actual thickness is greater than the preset thickness, the pressure of the primary pressing roller 11 applied on the spreading roller 12 is increased. When the actual thickness is less than the preset thickness, the pressure of the primary pressing roller 11 that is applied on the spreading roller 12 is decreased. When the actual thickness is equal to the preset thickness, the pressure of the primary pressing roller 11 that is applied to the spreading roller 12 is unchanged.

The driving unit 23 is coupled with the first pressing roller 11, and is configured for driving the first pressing roller 11 according to the driving signals. In the embodiment, the driving unit 23 is a motor or an air cylinder.

When the pressure of the primary pressing roller 11 applied on the spreading roller 12 is needed to be increase, the first pressing roller 11 is driven to move toward the spreading roller 12 by the driving unit 23. When the pressure of the primary pressing roller 11 applied on the spreading roller 12 is need to decrease, the first pressing roller 11 is driven to move away the spreading roller 12 by the driving unit 23. When the pressure of the primary pressing roller 11 that is applied on the spreading roller 12 is unchanged, the first pressing roller 11 is not driven to move.

In use, the thin film 201 is transported along a direction from the first primary pressing roller 11 to the guiding roller 14. The spurting device 15 spurts the glue 151 on the thin film 201. The spreading roller 12 uniformly spreads the glue 151 to form the glue layer 202. The micro-structures 122 are rolled over the glue layer 202, and the optical structures 2021 corresponding to the micro-structures 122 are formed on the glue layer 202.

The detecting unit 21 detects the actual thickness of the glue layer 202, and outputs the actual thickness to the processor 22. The processor 22 compares the actual thickness with the preset thickness, and outputs the different driving signals calculated according to the different thickness difference between the preset thickness and the actual thickness. The driving unit 23 drives the primary pressing roller 11 to move away or toward the spreading roller 12 according to the driving signals, and a pressure of the primary pressing roller 11 that is applied on the spreading roller 12 is changed.

Particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A glue spreading system, comprising:
a spreading unit, comprising:
a primary pressing roller; and
a spreading roller adjacent to the primary pressing roller, a thin film transporting between the primary pressing roller and the spreading roller, and the spreading roller configured for spreading a glue layer on the thin film; and
a control unit, comprising:
a detecting unit configured for detecting an actual thickness of the glue layer;
a processor receiving the actual thickness from the detecting unit and comparing the actual thickness with a preset thickness, and outputting different driving signals according to different thickness differences between the actual thickness and the preset thickness; and
a driving unit coupled to the primary pressing roller, and driving the first pressing roller to move away or toward the spreading roller according to the driving signals.

2. The glue spreading system of claim 1, wherein the spreading unit comprises a spurting device positioned above the primary pressing roller, the spurting device spurts a glue on the thin film, the glue is spread to form the glue layer by the spreading roller.

3. The glue spreading system of claim 2, wherein the primary pressing roller faces one side of the thin film, and the spreading roller and the spurting device face another side of the thin film.

4. The glue spreading system of claim 1, wherein the spreading roller comprises an outer surface and a plurality of micro-structures on the outer surface; the micro-structures are rolled over the glue layer to form optical structures.

5. The glue spreading system of claim 1, wherein the processor is electrically connected between the detecting unit and the driving unit.

6. The glue spreading system of claim 1, wherein each driving signal corresponds to a pressure of the primary pressing roller needed to add on the spreading roller.

7. The glue spreading system of claim 6, wherein when the pressure of the primary pressing roller applied on the spreading roller needs to increase, the first pressing roller is driven to move toward the spreading roller by the driving unit; when the pressure of the primary pressing roller applied on the spreading roller needs to decrease, the first pressing roller is driven to move away the spreading roller by the driving unit.

8. A glue spreading system, comprising:
a spreading unit, comprising:
a primary pressing roller; and
a spreading roller adjacent to the primary pressing roller, a thin film transporting between the primary pressing roller and the spreading roller, and the spreading roller configured for spreading a glue layer on the thin film; an actual thickness of the glue layer decided by a pressure of the primary pressing roller applied on the spreading roller; and
a control unit configured for detecting the actual thickness of the glue layer, and comparing the actual thickness with a preset thickness; the control unit controlling the pressure of the primary pressing roller applying on the spreading roller according to thickness differences between the actual thickness and the preset thickness.

9. The glue spreading system of claim 8, wherein when the pressure of the primary pressing roller applied on the spreading roller needs to increase, the first pressing roller is driven to move toward the spreading roller by the driving unit; when the pressure of the primary pressing roller applied on the spreading roller needs to decrease, the first pressing roller is driven to move away the spreading roller by the driving unit.
